(19) United States
(12) Patent Application Publication
(10) Pub. No.: US 2025/0046278 A1
(43) Pub. Date: Feb. 6, 2025

(54) SYSTEM FOR DIGITAL CONTROL OF AN ANALOG PEDAL

(71) Applicant: Audible Dynamics, LLC, Miami, FL (US)

(72) Inventors: David Mosquera, Miami, FL (US); Jonathan Au, Miami, FL (US); Marlon Castro, Miami, FL (US); Kevin Fernandez, Miami, FL (US); Aiden Shi, Miami, FL (US)

(21) Appl. No.: 18/884,756

(22) Filed: Sep. 13, 2024

(51) Int. Cl. G10H 1/00

(52) U.S. Cl. CPC G10H 1/0008; G10H 1/0091; G10H 2210/311; G10H 2210/315; G10H 2220/116; G10H 2220/265

(57) ABSTRACT

A system for digital control of an analog pedal has an analog audio circuit. The analog audio circuit receives an analog audio signal as an input audio signal and processes the input audio signal into an output analog audio signal. A digital control system is operatively coupled to the analog audio circuit. The digital control system receives a user input and outputs a control signal to the analog audio circuit as a function of the user input. The analog audio circuit modifies the audio signal into the output analog audio signal as a function of the control signal.

### BACKGROUND OF THE INVENTION

The present invention is directed to a pedal structure for modifying the output of an electric instrument, such as a guitar, and more particularly utilizing a digital control to control the effects of the analog pedal to the output of the musical instrument.

It is known in the art that guitarists utilize guitar pedals to creatively shape their sound. These pedals typically employ analog or digital processing methods, yet each has unique advantages and disadvantages.

In analog form they suffer from the disadvantage that they require the manual tuning of a number of potentiometers, requiring a large device, and extensive effort to recreate the control settings to repeat desired sounds. These electrical characteristics have historically been manipulated using analog potentiometers that are manually turned by the user. Because of this method of control, the size of an analog audio device has traditionally been inherently and proportionally linked to the versatility of the effect. Put simply, the more parameters that can be changed on a given audio effect, the more knobs are needed to control them. The more knobs on a device, the larger that device must be, which increases the size of the case as well. With the increase in case size and knob count comes an increase in manufacturing costs. This is in addition to the inconvenience of transporting and setting up the device where needed. The increase in knob count also increases the potential for failure of the device over time, as physical knobs are mechanical parts that are inherently prone to degradation, especially in consumer applications where costs are generally limited.

The use of digital pedals reduces the form factor of the device, but in digital form the pedal suffers from the disadvantage that digitizing audio signals “cuts off” the signal. To musicians and fans this damages the purity of the sound, limiting the creative output.

Accordingly, a structure to overcome the shortcomings of the prior art is provided.

### SUMMARY OF THE INVENTION

A system for digital control of an analog pedal has an analog audio circuit. The analog audio circuit receives an analog audio signal as an input audio signal and processes the input audio signal into an output analog audio signal. A digital control system is operatively coupled to the analog audio circuit. The digital control system receives a user input and outputs a control signal to the analog audio circuit as a function of the user input. The analog audio circuit modifies the audio signal into the output analog audio signal as a function of the control signal.

In one embodiment of the invention, the system includes a power circuit. The power circuit provides a power input to the analog audio circuit and the digital control system as conditioned power signals.

In yet another embodiment of the invention the analog audio circuit includes at least one of a distortion circuit for distorting the received audio signal and an equalizer circuit for equalizing the received audio signal.

In still another embodiment of the invention the invention, the digital control system includes a user interface. The user interface receives the user input and outputs a logic signal as an output. A microcontroller receives the logic signals and as function thereof outputs the control signal to the analog audio circuit as inputs to the equalizer circuit and the distortion circuit.

In yet another embodiment of the invention the audio circuit incorporates digipots for manipulating the audio signal. Signal conditioners are provided to enable the digipots to operate in a manner conducive for manipulating the audio output of the analog audio effect circuit.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 is a block diagram of a system for digital control of an analog pedal constructed in accordance with the invention;

FIG. 2 is a block diagram of a power supply constructed in accordance with the invention;

FIG. 3 is a block diagram of an analog audio circuit constructed in accordance with the invention;

FIG. 4 is a block diagram of a digital control circuit constructed in accordance with the invention;

FIG. 5 is a block diagram of an exemplary effect module of the analog audio circuit constructed in accordance with the invention;

FIG. 6 is a block diagram of a digital control circuit constructed in accordance with another embodiment of the invention; and

FIG. 7 is a circuit diagram for the of the signal conditioner circuit.

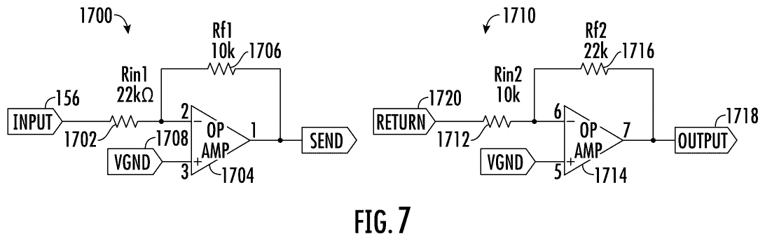

### DETAILED DESCRIPTION OF THE PREFERRED EMBODIMENTS

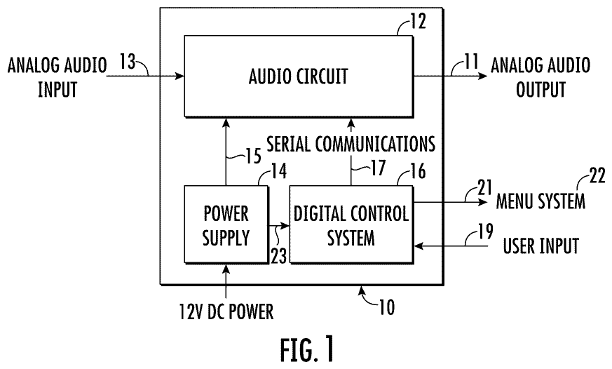

Reference is first made to FIG. 1 in which a system, generally indicated as 10, for digital control of an analog signal is provided. System 10 receives as a first input an analog audio signal 13, such as a musical note from an electric guitar by way of non-limiting example. System 10 includes an analog audio circuit 12 which receives the analog audio signal 13 as an input audio signal and processes the analog signal into an analog audio output signal 11.

System 10 includes a digital control system 16 which is operatively coupled to the analog audio circuit 12. Digital control system 16 provides signals 21 to a menu system 22 to display control options to a user. Conversely, digital control system 16 receives a user input 19, as an input at menus system 22 in a non-limiting embodiment, and outputs a serial communication control signal 17 to the analog audio circuit 12 as a function of the user input 19 at menu system 22. In a preferred non limiting embodiment serial communication control signal 17 is in the form of a serial instruction signal. The analog audio circuit 12 modifies the audio signal 13 into an analog audio output signal 11 as a function of the serial communication control signal 17.

System 10 includes a power supply 14 which in a non-limiting embodiment receives a DC voltage and conditions the voltage into a number of conditioned voltage signals, shown as 15 and 23 for clarity (FIG. 1), input to analog audio circuit 12 and digital control system 16 respectively.

During operation system 10 receives the output of an electric guitar, in one non limiting embodiment, as analog audio input 13. Analog audio circuit 12 receives the analog audio input 13 and the serial communication control signals 17, as serial communication signals in one non limiting embodiment, from digital control system 16. Analog audio circuit 12 operates on the analog audio input 13 as a function of parameters input as serial communication signals 17 to output a modified signal as analog audio output 11. By employing analog circuitry for effects and leveraging digital controls, system 10 offers the best of both worlds. The sound quality of an analog pedal with the ease of use of a digital pedal.

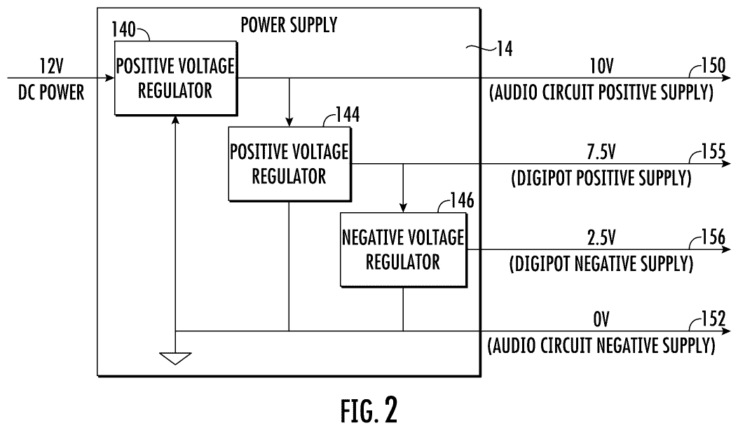

Reference is now also made to FIG. 2 in which the structure of power supply 14 is provided with greater particularity. Power supply 14 regulates the voltages, steps them down, to be used by the various components of system 10. In one non limiting embodiment power supply 14 consists of four subcircuits: a first positive linear voltage regulator circuit 140 which reduces the 12V input voltage to 10V. A second positive linear voltage regulator circuit 144 receives the voltage from first positive linear voltage regulator 140 and outputs a 7.5V signal at line 155 as an output of power supply 14 and as an input to a negative linear voltage regulator 146, which in response thereto outputs a voltage of 2.5V at line 156.

As can be seen, the input of one of the positive regulators 140 is 12V DC power, and its output is 10V. The second positive linear voltage regulator 144 has the 10V rail as its sole input. Positive linear voltage regulator 144 has the 7.5V rail 155 as its output. The negative linear voltage regulator circuit 146 has the 7.5V rail 155 as its input and the 2.5V rail 156 as its output. It should be noted that the voltage level at rail 152 is zero volts and is input to the audio circuit at a negative voltage input.

Positive linear voltage regulator 140 brings the 12V input down to 10V to function as the supply voltage of analog audio circuit 12 and the rest of the power supply 14. Positive linear voltage regulator 144 brings the 10V rail down to 7.5V to be used as the power supply of the digital control system 16. Negative linear voltage regulator brings the 7.5V rail 156 down to a 2.5V current sinking voltage at rail 156 to function as the ground rail of the digital control system 16.

Using power supply 14 as described above enables the use of digipots to condition the audio signal; enabling the digital control of the audio signal in an efficient construction. The problem with designing audio circuits around digipots is that they have power supply requirements that are mismatched from integrated circuits (“IC”) commonly used in analog audio effect circuits. For example, most digipots in the Microchip (e.g. MCP401X, MCP413X) and Analog Devices (e.g. AD512X) families of digipots have acceptable voltage ranges in the neighborhood of 5.5V. This means that any audio signal passed through a digipot of this type must have a peak-to-peak voltage of 5.5V (since the signals passing through these devices must be within the supply voltage range of the analog device). On the other hand, prior art off the shelf audio ICs have minimum supply voltage ranges at the 9V or 10V level (NE5532, most BBD ICs, etc.). This means that digipots cannot be simply dropped into analog audio circuits that use these ICs.

However, with the inventive design an audio signal runs through a gain stage driven by a ±4.5V supplied op-amp. If the gain is high enough for the audio signal to hit the headroom of the amplifier, the amplitude of the audio signal at its peaks would be beyond ±2.7V (the voltage supply limit of most digipots). Once the signal passes through a digipot, the parts of the signal above and below the digipot's voltage supply rails will be distorted, which in the vast majority of design cases will not match with the intended effect of the circuit and the operation of the digipot.

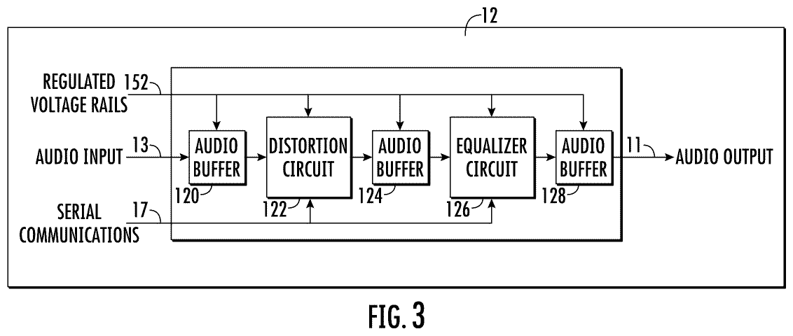

Reference is now made to FIG. 3, in which the analog audio circuit 12 is shown in greater detail. Analog audio circuit 12 includes, in a non-limiting embodiment, in series a first audio buffer 120 which provides an input to a distortion circuit 122. Distortion circuit 122 “colors” the sound, with harmonic distortion and clipping, corresponding to audio input signal 13, and provides a distorted sound signal as an input to a second audio buffer 122 which in turn provides an input to equalizer circuit 126. Equalizer circuit 126 provides selectable filters for frequencies within the analog audio signal 13 by boosting and attenuating selected frequencies and outputs the filtered signal to a third audio buffer 128 which in turn outputs the signal as analog audio signal output 11. Audio buffers 120, 124, 128 prevent signal degradation.

Each of the above-named components receives a regulated voltage input from rail 156. The distortion and equalizer circuits 122, 126 also take serial communications from the digital control system as control signals to provide the parameters for the operation of each. Distortion circuit 122 and equalizer circuit 126 are each modules, in a preferred nonlimiting embodiment, and are described here as exemplars of signal processing sub circuitry for case of description. Modules are interchangeable, and it is well within the scope of the invention to have other or different modules performing different functionality on the signal such as delay, etc. Under the control of serial communications control signal 17 each parameter of each module may operate between full strength (maximum effect) and no strength (minimal effect) or at levels in between as a function of the operation of digital control system 16.

The solution this invention employs is to condition the audio signal for passage through each digipot; before and after passing through each digipot, the signal is attenuated and boosted (respectively) by a fixed gain. This gain matches with the ratio between the voltage supply of the digipot and that of the rest of the audio circuit. For example, if the voltage supply of a digipot is 5V, but the voltage supply of the rest of the circuit is 10V, the gain of the signal conditioner is 2. Take a signal with an amplitude of 5V, or 10V peak-to-peak. Passing this signal through a digipot with a 5V supply will distort the signal, but amplifying the signal by a gain of 0.5 (to 2.5V amplitude or 5V peak-to-peak) will make the signal fall within the range of the digipot's voltage supply. Once the signal passes through the digipot, it can be amplified by the reciprocal gain of 2 to return to the amplitude of the original signal.

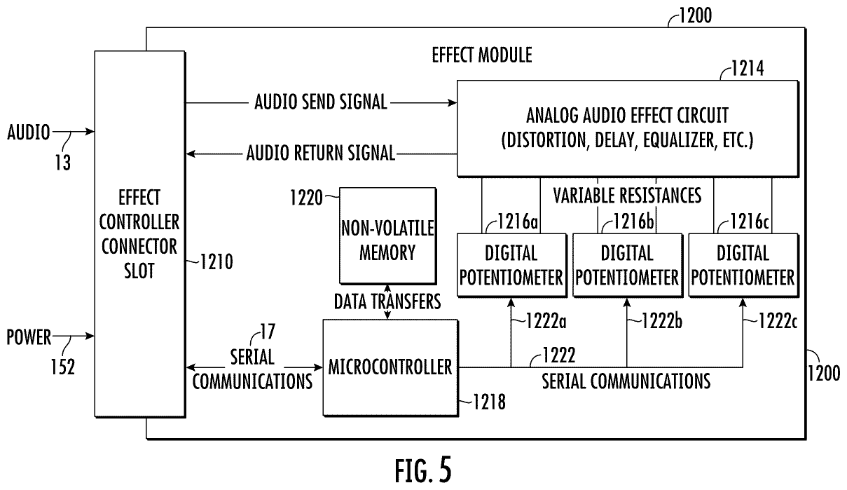

Reference is now made to FIG. 5 in which an example of a preferred alternative embodiment of a subcircuit analog effect module, generally indicated as 1200, is provided. Module 1200 includes an analog audio effect circuit 1214. Analog audio effect circuit 1214 process the effect, such as distortion, equalizer, delay or the like, on the analog audio signal (audio send signal). An effect controller connector slot 1210 is a physical connector and receives the buffered analog audio signal as the audio send signal and power input from line 156 as discussed above. Module 1200 includes a microcontroller 1218 which receives the serial communications 17, and using information stored in a nonvolatile memory 1220, outputs serial communication signals 1222a-1222n, to one or more digital potentiometers (“digipots”) 1216a-1216n. Digipots 1216a-1216n function as variable resistances that enable the analog audio effect circuit 1214 to vary effects of its parameters on the audio send signal. Analog audio effect circuit 1214 outputs the processed signal as the audio return signal to the effect controller connector slot.

The audio signal must be conditioned before it can be used by the digipots 1216a-1216n. Analog audio effect circuit 1214 includes conditioning circuit 1700, which provides the five volt peak to peak signal which can pass through digipots 1216a-n. A resistor 1702, preferably a 22 kΩ resistor in this nonlimiting embodiment, is disposed between the audio input and the negative input of an operational amplifier (“op amp”) 1704. A second resistor 1706, preferably a 10 kΩ is in parallel across op amp 1704. This is the conditioned audio signal that is then suitable to pass through any of digipots 1216a-n. The structure described above fixes the mismatch between the voltage ranges these parts require.

Once the signal passes through the digipot(s) from 1216a-1216n for which it was conditioned, it is operated upon again. A second conditioning circuit 1710 amplifies the voltage of the signal which has passed through the digipots 1216a-n that the signal was originally conditioned for by conditioning circuit 1700. Conditioning circuit 1710 receives the output audio signal of digipots 1216a-1216n. A resistor 1706, preferably a 22 kΩ is connected across the negative input terminal and output terminal of an op amp 1714. A second resistor 1702, preferably a 10 kΩ resistor in this nonlimiting embodiment, is disposed between the negative input of op amp 1714 and return 1720. This is the audio signal that has already passed through one or more of digipots 1216a-n. The signal conditioner's sole purpose is to scale the amplitude of the audio signal down from whatever is the “analog amplitude” of the system (in the preferred embodiment, 10V) down to the “digipot amplitude” of the system (whatever the power supply voltage differential for the digipots is, in our case 5V) for it to pass through the digipots and then back up after passing through the digipots. Thus, the signal conditioner is actually a member of the analog audio circuit and does not appear in any other diagrams explicitly.

To simplify the design complexity of the signal conditioner, the power supply voltage of the digipots is centered around the same voltage as the rest of the audio circuit. If the voltage supply of the audio circuit is +10V and 0V, the supply is centered around 5V. For a digipot supplied with 5V power to be centered around 5V, the positive and negative voltages should be 7.5V and 2.5V, respectively. When the digipots are powered with these voltages and the audio signal has a de bias of 5V, then the signal conditioner only needs to consist of two inverting operational amplifiers operating with 5V as the ground. FIG. 2 shows an example for the design of a power supply for the system.

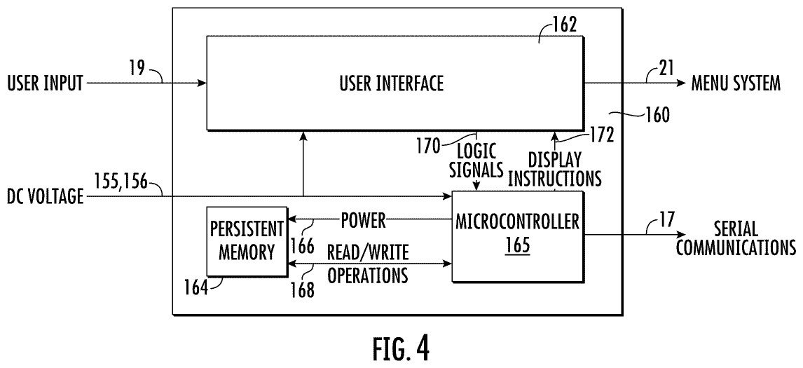

It should be known that the number of conditioning circuits can vary as a function of design. For some effects, there are digipots where the audio signal needs no signal conditioning at all, because it's already known by design that the voltage of the audio signal at that point in the circuit will always be within “digipot amplitudes” without further modification. Sometimes, one signal conditioner can be used for multiple digipots. For example, there may be a series of tone stages in a circuit, where each tone stage has two RC filters joined together with a digipot, the wiper position of which determines how the RC filters (one high pass, one low pass) mix at the output. By way of one non limiting example, if there are three such tone stages in series, none of these stages amplify the audio signal whatsoever. Thus, we know that we need only one signal conditioner for this arrangement: the “Send” of that conditioner (the attenuated “digipot amplitude” audio signal) will go to the input of the first tone stage in the series, while the “Return” to the conditioner (the audio signal that will be boosted back to “analog amplitude”) will come from the output of the last tone stage in the series. In this case, one signal conditioner was used for three digipots. Reference is now made to FIG. 4 in which the structure for digital control system 16 is provided. Digital control system 16 processes the user input 19 to control the analog audio circuit 12 and provides a menu system 21 to the user. Digital control system 16 includes a user interface 162. A microcontroller 165 communicates with user interface 162 and a persistent memory 164. Persistent memory 164 stores the control instructions for operating analog audio circuit 12.

In a preferred non limiting example, the persistent memory 164 is intended to signify something like an SD card or some onboard flash memory that holds profiles for the user to access, not really instructions for how microcontroller 165 controls audio circuit 12. However, the instructions for controlling the audio circuit do exist on persistent memory, it just happens to be the persistent memory that holds the main program of the microcontroller, not the distinct persistent memory that holds the profiles.

During operation, user interface 162 receives user input 19. In response to the indicated parameters within user input 19, user interface 162 outputs logic signals 170 to the microcontroller 165 and through the menu system 21 back to the user. Microcontroller 165 receives DC voltage 24 and logic signals 170 and communicate with persistent memory 164 to use data stored within persistent memory 164 to create control signals as serial communications 17 which are input to analog audio circuit 12 to control operation on the audio signal.

As can be seen from the above, as a result of the above structure, user interface 162 outputs logic signals 170 to the microcontroller 165 and 21 to the user at the menu system 21. The microcontroller 165 takes DC voltage 24 from the power supply 14 and logic signals 170 from the user interface 162. Microcontroller 165 outputs display instructions 172 to the user interface 162 and control signals 17 to the analog audio circuit 12. The persistent memory 164 is powered by the microcontroller 165 and sends/receives data as a read write operation 1678 to/from the microcontroller 165.

The user interface 162 may include physical controls for the user to manipulate to provide input to the system 10. The user interface 162 may also use a visual medium to provide a menu system 21 for the user and a graphical user interface (“GUI”) providing virtual controls as user input 19. User interface 162 communicates with the microcontroller 165 to send the user input 19 and receive the data to display to the user through the menu 21. Microcontroller 165 drives the logic of the system. Microcontroller 165 processes input from the user interface 162 to control the analog audio circuit 12 and retains the state in accordance with inputs selected by a user at the menu 21 that the user is interacting with. The persistent memory 164 provides a way for the user to store their profile settings.

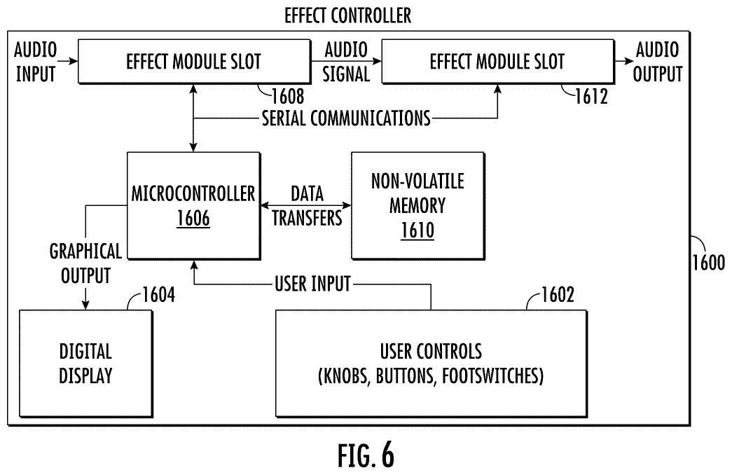

Reference is now made to FIG. 6 where in a digital control system, generally indicated as 1600, constructed in accordance with another embodiment of the invention is provided. Digital control system 1600 includes a microcontroller 1606, a nonvolatile memory 1610 for storing data about settings for desired effects from an effect module, and a user controls 1602. Microcontroller 1606 receives a user input from user controls 1602 and from non-volatile memory 1610. User controls 1602 may be virtual such as a graphical user interface, or physical, such as knobs, buttons, footswitches or the like, or a combination of both. Microcontroller 1606 is in communication with a digital display 1604 which may act as the menu.

Microcontroller 1218 is a processor that is specifically programmed to control the analog audio effect circuit 1214 of its given effect module. Microcontroller 1218 communicates with processor 1606 in the effect controller to carry out the task of manipulating the digipots in the effect module 1200 (and by extension, manipulate the audio signal). Microcontroller 1218 performs two specific functions. one is to inform processor 1606 of the various characteristics of the effect module 1200 so that processor 1606 will “understand” how to present the function of this effect to the user via digital display 1604 (displaying the name of the effect and the names of its parameters, for example) without having that data programmed into processor 1606 and thus ensuring modularity. The other function is to handle all of the direct communication with the digipots so that it can be abstracted from processor 1606.

Digital control system 1600 further includes a first effect module slot 1608, communicating with analog audio circuit 12, and more specifically an effect module 1200. Effect module 1608 receives analog audio signal to be processed. First effect module slot 1608 communicates with microcontroller 1606, as does a second effect module slot 1612. Micro controller 1606, as a function of the user input from user controls 1602 and data stored in non-volatile memory 1610, outputs control signals as serial communications to each of first effect module slot 1608 and second effect module slot 1612. in this way the serial communications are provided to the necessary circuits of analog audio circuit 12.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

The structure outlined above, decouples the complexity of an analog audio effect from the complexity of its manufacture, providing a boon to both the user and manufacturer.

The system described above accomplishes the decoupling with two major features: the effect module's use of digipots and the delegation of the user interface from the audio effect device onto a controller. The digipots as part of the control structure allow for the shrinking of user interfaces in a straightforward manner. Once analog potentiometers are replaced by digipots, any method of digital control of those digipots can allow for dynamic assignment of the analog parameters to the physical controls on the analog portion of the device. The ability to do this means that one physical knob and one button can theoretically control an infinite number of analog parameters.

The system was described herein in connection with a pedal for a guitar. however, this was to simplify the disclosure. The input signal can be any audio signal from any electric instrument, even including inputs to a microphone.

It is also to be understood that the following claims are intended to cover all of the generic and specific features of the invention herein described, and all statements of the scope of the invention which, as a matter of language, might be said to fall therebetween.

1. A system for digital control of an analog pedal comprising:
an analog audio circuit; the analog audio circuit receiving an analog audio signal as an input audio signal and processing the analog signal into an output analog audio signal;
a digital control system operatively coupled to the analog audio circuit, the digital control system receiving a user input and outputting a control signal to the analog audio circuit as a function of the user input; and the analog audio circuit modifying the audio signal into the output analog audio signal as a function of the control signal.

2. The system of claim 1, wherein the analog audio circuit comprises at least one of a distortion circuit for distorting the received audio signal and an equalizer circuit for equalizing the received audio.

3. The system of claim 2, wherein the digital control system comprises a user interface, the user interface receiving the user input and outputting a logic signal as an output; a microcontroller receiving the logic signal, and as function thereof, outputs the control signal to the analog audio circuit as inputs to the equalizer circuit and the distortion circuit.

4. The system of claim 1, wherein the digital control system comprises a user interface, the user interface receiving the user input and outputting a logic signal as an output; a microcontroller receiving the logic signal, and as function thereof, outputs the control signal to the analog audio circuit.

5. The system of claim 1, further comprising a power circuit; the power circuit providing a power input to the analog audio circuit and the digital control system as conditioned power signals.

6. The system of claim 1, wherein the analog audio circuit comprises at least one effect circuit operating on the analog audio signal to provide an effect to the analog audio signal, at least one effect circuit having an analog audio effect circuit and a microcontroller; the microcontroller providing control signals as serial communications to the analog audio effect circuit; the effect circuit receiving an audio send signal corresponding to the input audio signal, and operating on the audio send signal as a function of the control signals, and producing an audio return signal.

7. The system of claim 6, wherein the analog audio circuit further comprises one or more digipots for receiving the control signals and outputting the control signal to the analog audio effect circuit.

8. The system of claim 6, wherein the digital control system provides an input to the at least one effect circuit, and comprises a user controls, the user controls receiving the user input and producing a user input signal as an output; a second microcontroller receiving the user input signal, and as function thereof, outputs the control signal as inputs to the at least one effect circuit.
